(19) United States
(12) Patent Application Publication
(10) Pub. No.: US 2013/0332168 A1
(43) Pub. Date: Dec. 12, 2013

(54) VOICE ACTIVATED SEARCH AND CONTROL FOR APPLICATIONS

(71) Applicant: Samsung Electronics Co., Ltd., Suwon (KR)

(72) Inventors: Byoungju Kim, Walnut Creek, CA (US); Prashant Desai, San Francisco, CA (US)

(21) Appl. No.: 13/912,035

(22) Filed: Jun. 6, 2013

Related U.S. Application Data
(60) Provisional application No. 61/781,693, filed on Mar. 14, 2013.
(60) Provisional application No. 61/657,575, filed on Jun. 8, 2012.

(51) Int. Cl. G10L 15/22

(52) U.S. Cl. CPC G10L 15/22
USPC 704/251

(57) ABSTRACT

A method for voice activated search and control comprises converting, using an electronic device, multiple first speech signals into one or more first words. The one or more first words are used for determining a first phrase contextually related to an application space. The first phrase is used for performing a first action within the application space. Multiple second speech signals are converted, using the electronic device, into one or more second words. The one or more second words are used for determining a second phrase contextually related to the application space. The second phrase is used for performing a second action that is associated with a result of the first action within the application space.

### CROSS-REFERENCE TO RELATED APPLICATIONS

This application claims the priority benefit of U.S. Provisional Patent Application Ser. No. 61/657,575, filed Jun. 8, 2012, and U.S. Provisional Patent Application Ser. No. 61/781,693, filed Mar. 14, 2013, both incorporated herein by reference in their entirety.

### TECHNICAL FIELD

One or more embodiments relate generally to voice activated actions and, in particular, to voice activated search and control for applications.

### BACKGROUND

Automatic Speech Recognition (ASR) is used to convert uttered speech to a sequence of words. ASR is used for user purposes, such as dictation. Typical ASR systems convert speech to words in a single pass with a generic set of vocabulary (words that the ASR engine can recognize).

### SUMMARY

In one embodiment, a method provides voice activated search and control. One embodiment comprises a method that comprises converting, using an electronic device, a first plurality of speech signals into one or more first words. In one embodiment, the one or more first words are used for determining a first phrase contextually related to an application space. In one embodiment, the first phrase is used for performing a first action within the application space. In one embodiment, a plurality of second speech signals are converted, using the electronic device, into one or more second words. In one embodiment, the one or more second words are used for determining a second phrase contextually related to the application space. In one embodiment, the second phrase is used for performing a second action that is associated with a result of the first action within the application space.

In one embodiment, a system provides for voice activated search and control. In one embodiment, the system comprises an electronic device including a microphone for receiving a plurality of speech signals. In one embodiment, an automatic speech recognition (ASR) engine converts the plurality of speech signals into a plurality of words. In one embodiment, an action module uses one or more first words for determining a first phrase contextually related to an application space of the electronic device, uses the first phrase for performing a first action within the application space, uses one or more second words for determining a second phrase contextually related to the application space, and uses the second phrase for performing a second action that is associated with a result of the first action within the application space.

In one embodiment, a non-transitory computer-readable medium having instructions which when executed on a computer perform provides a method comprising: converting a first plurality of speech signals, using an electronic device, into one or more first words. In one embodiment, the one or more first words are used for determining a first phrase contextually related to an application space. In one embodiment, the first phrase is used for performing a first action within the application space. A second plurality of speech signals are converted, using the electronic device, into one or more second words. In one embodiment, the one or more second words are used for determining a second phrase contextually related to the application space. In one embodiment, the second phrase is used for performing a second action that is associated with a result of the first action within the application space.

These and other aspects and advantages of the one or more embodiments will become apparent from the following detailed description, which, when taken in conjunction with the drawings, illustrate by way of example the principles of the one or more embodiments.

### BRIEF DESCRIPTION OF THE DRAWINGS

For a fuller understanding of the nature and advantages of the one or more embodiments, as well as a preferred mode of use, reference should be made to the following detailed description read in conjunction with the accompanying drawings, in which:

FIG. 1 shows a schematic view of a communications system, according to an embodiment.

FIG. 2 shows a block diagram of an architecture system for voice activated search and control for an electronic device, according to an embodiment.

FIG. 3 shows an example of contextual speech signal parsing for an electronic device, according to an embodiment.

FIG. 4 shows an example scenario for voice activated searching within an application space for an electronic device, according to an embodiment.

FIG. 5 shows an example scenario for voice activated control within an application space for an electronic device, according to an embodiment.

FIG. 6 shows a block diagram of a flowchart for voice activated control within an application space for an electronic device, according to an embodiment.

FIG. 7 shows a computing environment for implementing an embodiment.

FIG. 8 shows a computing environment for implementing an embodiment.

FIG. 9 shows a computing environment for voice activated search and control, according to an embodiment.

FIG. 10 shows a block diagram of an architecture for a local endpoint host, according to an example embodiment.

FIG. 11 is a high-level block diagram showing an information processing system comprising a computing system implementing an embodiment.

### DETAILED DESCRIPTION

The following description is made for the purpose of illustrating the general principles of the embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to voice activated search and control contextually related to an application space for an electronic device. In one embodiment, the electronic device comprises a mobile electronic device capable of data communication over a communication link such as a wireless communication link. Examples of such mobile device include a mobile phone device, a mobile tablet device, etc.

In one embodiment, a method provides voice activated search and control. One embodiment comprises converting, using an electronic device, a first plurality speech signals into one or more first words. In one embodiment, the one or more first words are used for determining a first phrase contextually related to an application space of an electronic device. In one embodiment, the first phrase is used for performing a first action within the application space. In one embodiment, a second plurality speech signals are converted, using the electronic device, into one or more second words. In one embodiment, the one or more second words are used for determining a second phrase contextually related to the application space. In one embodiment, the second phrase is used for performing a second action that is associated with a result of the first action within the application space.

One or more embodiments enable a user to use natural language interaction to quickly locate content, and carry out function/settings changes that are contextually related to an application space that the user is using. On embodiment provides functional capabilities based on the application the user is currently using, such as adjusting or changing settings, options, capabilities, priorities, etc.

In one embodiment, a user may activate the voice activated search or control features by pressing a button, touching a touch-screen display, etc. In one embodiment, activation may begin by long-pressing on a button (e.g., a home button). In one embodiment, as a user speaks a voice query, their electronic device performs an “instant search” that provides results immediately after each keyword is spoken and recognized. In one embodiment, a user may speak naturally and the voice signals are parsed into recognizable words for the application that the user is currently using. In one embodiment, the voice recognition functionality may terminate after a particular time period between spoken utterances (e.g., a two second silence, three second silence, etc.).

One or more embodiments provide voice query results in real-time with parallel processing. One embodiment recognizes compound statements and statements containing more than one subject matter or command; searches personal data stored on the electronic device; and may be used to make settings changes, and other functional adjustments. One or more embodiments are contextually aware of an active application space.

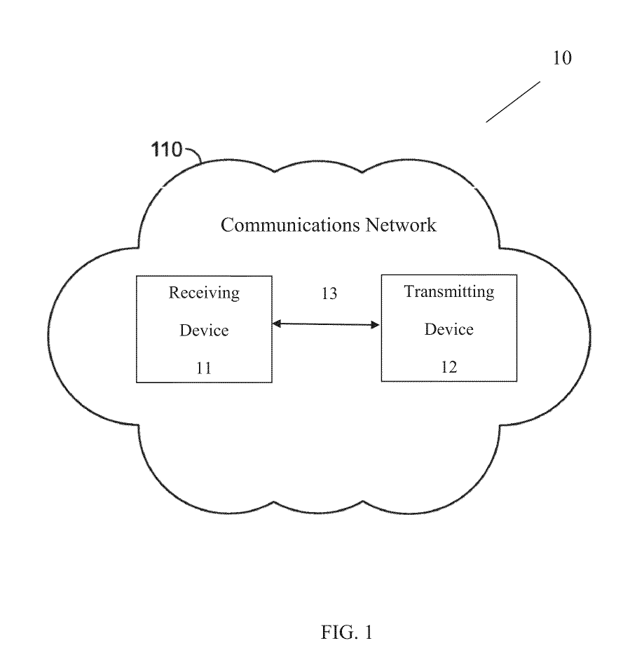

FIG. 1 is a schematic view of a communications system in accordance with one embodiment. Communications system 10 may include a communications device that initiates an outgoing communications operation (transmitting device 12) and communications network 110, which transmitting device 12 may use to initiate and conduct communications operations with other communications devices within communications network 110. For example, communications system 10 may include a communication device that receives the communications operation from the transmitting device 12 (receiving device 11). Although communications system 10 may include several transmitting devices 12 and receiving devices 11, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 110. Communications network 110 may be capable of providing communications using any suitable communications protocol. In some embodiments, communications network 110 may support, for example, traditional telephone lines, cable television, Wi-Fi (e.g., a 802.11 protocol), Bluetooth®, high frequency systems (e.g., 900 MHz, 2.4 GHz, and 5.6 GHz communication systems), infrared, other relatively localized wireless communication protocol, or any combination thereof. In some embodiments, communications network 110 may support protocols used by wireless and cellular phones and personal email devices (e.g., a Blackberry®). Such protocols can include, for example, GSM, GSM plus EDGE, CDMA, quadband, and other cellular protocols. In another example, a long range communications protocol can include Wi-Fi and protocols for placing or receiving calls using VOIP or LAN. Transmitting device 12 and receiving device 11, when located within communications network 110, may communicate over a bidirectional communication path such as path 13. Both transmitting device 12 and receiving device 11 may be capable of initiating a communications operation and receiving an initiated communications operation.

Transmitting device 12 and receiving device 11 may include any suitable device for sending and receiving communications operations. For example, transmitting device 12 and receiving device 11 may include a media player, a cellular telephone or a landline telephone, a personal e-mail or messaging device with audio and/or video capabilities, pocket-sized personal computers such as an iPAQ Pocket PC available by Hewlett Packard Inc., of Palo Alto, Calif., personal digital assistants (PDAs), a desktop computer, a laptop computer, and any other device capable of communicating wirelessly (with or without the aid of a wireless enabling accessory system) or via wired pathways (e.g., using traditional telephone wires). The communications operations may include any suitable form of communications, including for example, voice communications (e.g., telephone calls), data communications (e.g., e-mails, text messages, media messages), or combinations of these (e.g., video conferences).

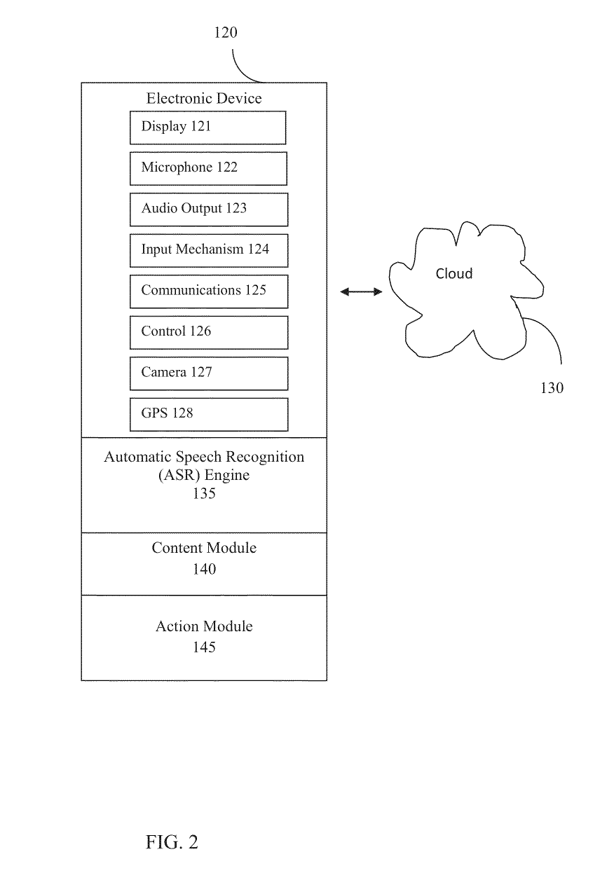

FIG. 2 shows a functional block diagram of an electronic device 120, according to an embodiment. Both transmitting device 12 and receiving device 11 may include some or all of the features of electronics device 120. In one embodiment, the electronic device 120 may comprise a display 121, a microphone 122, audio output 123, input mechanism 124, communications circuitry 125, control circuitry 126, a camera 127, a global positioning system (GPS) receiver module 128, an ASR engine 135, a content module 140 and an action module 145, and any other suitable components. In one embodiment, content may be obtained or stored using the content module 140 or using the cloud or network 130, communications network 110, etc.

In one embodiment, all of the applications employed by audio output 123, display 121, input mechanism 124, communications circuitry 125 and microphone 122 may be interconnected and managed by control circuitry 126. In one example, a hand held music player capable of transmitting music to other tuning devices may be incorporated into the electronics device 120.

In one embodiment, audio output 123 may include any suitable audio component for providing audio to the user of electronics device 120. For example, audio output 123 may include one or more speakers (e.g., mono or stereo speakers) built into electronics device 120. In some embodiments, audio output 123 may include an audio component that is remotely coupled to electronics device 120. For example, audio output 123 may include a headset, headphones or earbuds that may be coupled to communications device with a wire (e.g., coupled to electronics device 120 with a jack) or wirelessly (e.g., Bluetooth® headphones or a Bluetooth® headset).

In one embodiment, display 121 may include any suitable screen or projection system for providing a display visible to the user. For example, display 121 may include a screen (e.g., an LCD screen) that is incorporated in electronics device 120. As another example, display 121 may include a movable display or a projecting system for providing a display of content on a surface remote from electronics device 120 (e.g., a video projector). Display 121 may be operative to display content (e.g., information regarding communications operations or information regarding available media selections) under the direction of control circuitry 126.

In one embodiment, input mechanism 124 may be any suitable mechanism or user interface for providing user inputs or instructions to electronics device 120. Input mechanism 124 may take a variety of forms, such as a button, keypad, dial, a click wheel, or a touch screen. The input mechanism 124 may include a multi-touch screen. The input mechanism may include a user interface that may emulate a rotary phone or a multi-button keypad, which may be implemented on a touch screen or the combination of a click wheel or other user input device and a screen.

In one embodiment, communications circuitry 125 may be any suitable communications circuitry operative to connect to a communications network (e.g., communications network 110, FIG. 1) and to transmit communications operations and media from the electronics device 120 to other devices within the communications network.

Communications circuitry 125 may be operative to interface with the communications network using any suitable communications protocol such as, for example, Wi-Fi (e.g., a 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, or any other suitable protocol.

In some embodiments, communications circuitry 125 may be operative to create a communications network using any suitable communications protocol. For example, communications circuitry 125 may create a short-range communications network using a short-range communications protocol to connect to other communications devices. For example, communications circuitry 125 may be operative to create a local communications network using the Bluetooth® protocol to couple the electronics device 120 with a Bluetooth® headset.

In one embodiment, control circuitry 126 may be operative to control the operations and performance of the electronics device 120. Control circuitry 126 may include, for example, a processor, a bus (e.g., for sending instructions to the other components of the electronics device 120), memory, storage, or any other suitable component for controlling the operations of the electronics device 120. In some embodiments, a processor may drive the display and process inputs received from the user interface. The memory and storage may include, for example, cache, Flash memory, ROM, and/or RAM. In some embodiments, memory may be specifically dedicated to storing firmware (e.g., for device applications such as an operating system, user interface functions, and processor functions). In some embodiments, memory may be operative to store information related to other devices with which the electronics device 120 performs communications operations (e.g., saving contact information related to communications operations or storing information related to different media types and media items selected by the user).

In one embodiment, the control circuitry 126 may be operative to perform the operations of one or more applications implemented on the electronics device 120. Any suitable number or type of applications may be implemented. Although the following discussion will enumerate different applications, it will be understood that some or all of the applications may be combined into one or more applications. For example, the electronics device 120 may include an ASR application, a dialog application, a camera application including a gallery application, a calendar application, a contact list application, a map application, a media application (e.g., QuickTime, MobileMusic.app, or MobileVideo.app), etc. In some embodiments, the electronics device 120 may include one or several applications operative to perform communications operations. For example, the electronics device 120 may include a messaging application, a mail application, a telephone application, a voicemail application, an instant messaging application (e.g., for chatting), a videoconferencing application, a fax application, or any other suitable application for performing any suitable communications operation.

In some embodiments, the electronics device 120 may include microphone 122. For example, electronics device 120 may include microphone 122 to allow the user to transmit audio (e.g., voice audio) during a communications operation or as a means of establishing a communications operation or as an alternate to using a physical user interface. Microphone 122 may be incorporated in electronics device 120, or may be remotely coupled to the electronics device 120. For example, microphone 122 may be incorporated in wired headphones, or microphone 122 may be incorporated in a wireless headset.

In one embodiment, the electronics device 120 may include any other component suitable for performing a communications operation. For example, the electronics device 120 may include a power supply, ports or interfaces for coupling to a host device, a secondary input mechanism (e.g., an ON/OFF switch), or any other suitable component.

In one embodiment, a user may direct electronics device 120 to perform a communications operation using any suitable approach. As one example, a user may receive a communications request from another device (e.g., an incoming telephone call, an email or text message, an instant message), and may initiate a communications operation by accepting the communications request. As another example, the user may initiate a communications operation by identifying another communications device and transmitting a request to initiate a communications operation (e.g., dialing a telephone number, sending an email, typing a text message, or selecting a chat screen name and sending a chat request).

In one embodiment, the GPS receiver module 128 may be used to identify a current location of the mobile device (i.e., user). In one embodiment, a compass module is used to identify direction of the mobile device, and an accelerometer and gyroscope module is used to identify tilt of the mobile device. In other embodiments, the electronic device may comprise a stationary electronic device, such as a television or television component system.

In one embodiment, the ASR engine 135 provides speech recognition by converting speech signals entered through the microphone 122 into words based on vocabulary applications. In one embodiment, a dialog agent may comprise grammar and response language for providing assistance, feedback, etc. In one embodiment, the electronic device 120 uses an ASR 135 that provides for speech recognition that is contextually related to an application that a user is currently interfacing with or using. In one embodiment, the ASR module 135 interoperates with the action module for performing requested actions for the electronic device 120. In one example embodiment, the action module 145 may receive converted words from the ASR 135, parse the words based on the application that is currently being interfaced or used, and provide actions, such as searching for content using the content module 140, changing settings or functions for the application currently being used, etc.

In one embodiment, the ASR 135 uses natural language and grammar for parsing from a detected utterance based on a respective application space. In one embodiment, a probability of each possible parse is used for identifying a most likely interpretation of speech input to the action module 145 from the ASR engine 135.

In one embodiment, the content module 140 provides indexing and associating of metadata with content stored on the electronic device or obtained from the cloud 130. In one embodiment, the metadata may comprises an associated name or title, creation date, last accessed date, location information, point of interest (POI) information, album name or title, etc. In one embodiment, the metadata is contextually related to the type of content that it is associated with. In one example embodiment, for image type content, the metadata may comprises title or name of individual(s) in the image, a place or location, creation date, type of image (e.g., personal, social media image), last access date, album name or title, gallery name or title, storage location, etc. In another example, for media type content, metadata may comprise title or name of related to the media, a place or location where recorded, release date, type of media (e.g., video, audio, etc.), last access date, album name or title, song name or title, playlist name, storage location, artist name, actor(s) name, director name, etc.

In one embodiment, a portion of the metadata is automatically associated with content upon creation or storage on the electronic device 120. In one embodiment, a user may be requested to add metadata information for association with content upon creation. In one example, upon taking a photo or video, a user may be prompted to add a name or title, location to store, album to place in, etc. to associate with the photo or video, while the creation time and location (e.g., from the GPS module 128) may be added automatically. In one embodiment, a place or location may also be determined based on the image framed using GPS information and comparing the framed image to photo databases of known places in the location (e.g., the GPS information indicates the vicinity of an adventure park).

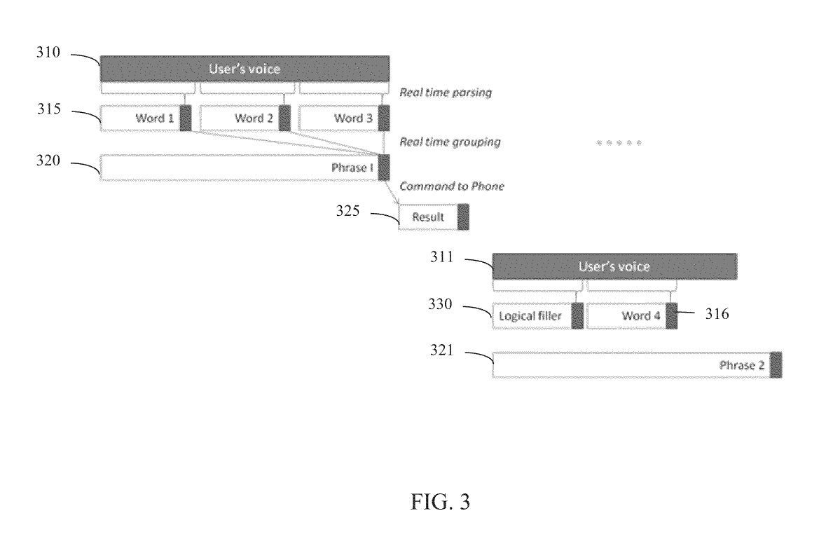

FIG. 3 shows an example of contextual speech signal parsing for an electronic device 120, according to an embodiment. In one embodiment, voice signals are entered through the microphone 122 via a user's voice 310. In one embodiment, the ASR 135 converts the speech into words 315 based on an application that the user is currently interfacing or using (e.g., a camera application, a media application, etc.). In one embodiment, the words are compared to a vocabulary for the particular application the user is interfacing with or using and a phrase 320 is determined based on the parsed words. In one embodiment, the phrase is compared to commands or actions using the action module 145 to provide an action (e.g., search for content within the application based on spoken metadata; change a setting within the application; change a function within the application; etc.).

In one embodiment, as a result of the action module 145 performing the requested action, the result 325 is provided to the user (e.g., on the display 121). In one embodiment, using the result 325, the user provides further speech signals 311. In one embodiment, the ASR 135 converts the user's voice signals to another word 316, and may add a logical filler word 330. In one example, after a user first entered a voice command for searching for photos of Dad, upon receiving a result of all photos of Dad, the user enters the word 2013. In this example, a logical filler 330 may be search results for the year, where the year is word 316 (e.g., 2013). In this embodiment, the logical filler word(s) 330 are contextually based on the application being interfaced or used by the user and also contextually based by the associated metadata for the application space (e.g., images, media, contacts, appointments, etc.).

In one embodiment, using the logical filler word(s) 330 and the converted word 316, a phrase 321 is provided to the action module 145 for performing the requested action (e.g., search the results (e.g., results 325) for the year 2013). In this example, the image results for the search for “Dad” are then searched for images of “Dad” form the year “2013.” In one embodiment, the results from the first search using the first words 315 are shown to the user on display 121. In one embodiment, if the user responds to the returned results with further requested actions (e.g., further searching) within a particular time period (e.g., two seconds, three seconds, etc.), the activation of the search and control features remain active.

In one embodiment, multiple related or chained speech signals result in multiple chained associated actions within the application space upon the multiple chained speech signals occurring within a particular time period (e.g., two seconds, three seconds, etc.). In this embodiment, a user searching for content may search through many content instances (e.g., hundreds, thousands, etc.) and continuously filter the returned results until the user is satisfied with the results.

In another embodiment, multiple chained actions may comprise multiple setting changes for an application currently being interfaced or used. For example, if the application is a camera or photo editing application, a user may first request to adjust contrast of an image frame, and continue to adjust the contrast until satisfied based on seeing the results from each action. In another example, settings such as turning flash on, making the flash automatic, turning a grid on, etc. may be chained together. In yet another example, a selection of a playlist, selecting year of songs, and selecting to randomly play the results may be chained together. As one can readily see, multiple actions and chained actions may be requested using contextual voice recognition for different application spaces.

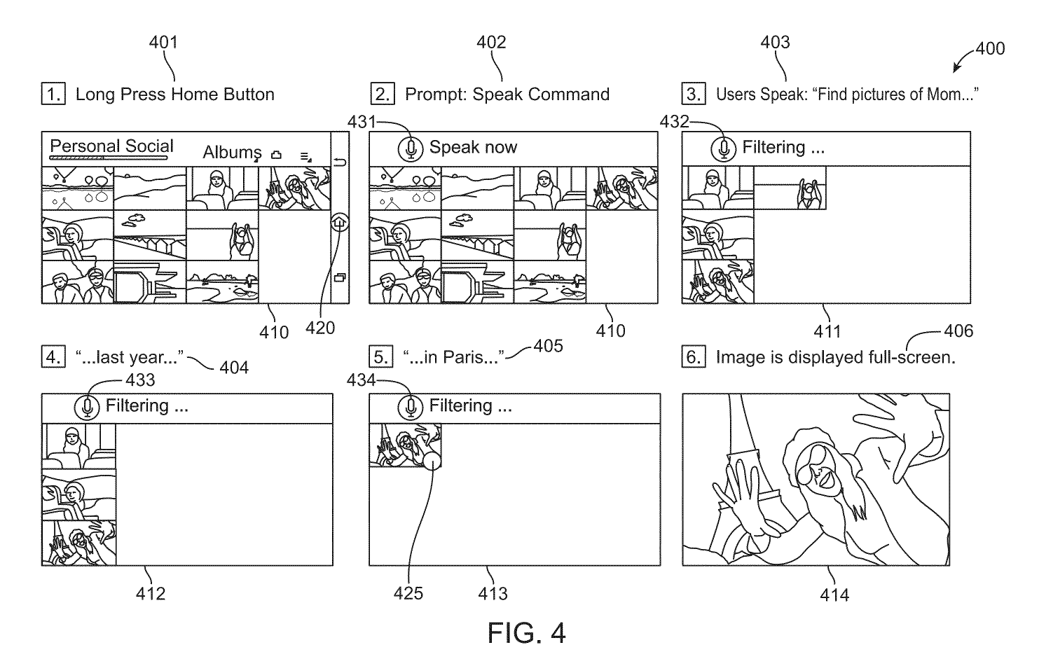

FIG. 4 shows an example scenario 400 for voice activated searching for content within an application space for an electronic device 120, according to an embodiment. In one embodiment, the example scenario 400 comprises a user interacting with a camera application, which may be associated with a gallery application showing a view 410 (e.g., on display 121) for arranging images for retrieval, display, sharing, etc. In one embodiment, a user activates the ASR 135 for receiving voice signals from a user by an activation event (e.g., long press 401 of a button 420, or any other appropriate activation technique).

In one embodiment, a dialog module responds to the activation 401 with a reply/feedback 431 (e.g., speak now) and prompts 402 the user to speak. In one embodiment, the user speaks 403 and utters the words “find pictures of Mom.” In one embodiment, feedback 432 is displayed to let the user know the electronic device 120 is processing the request. In other embodiments, feedback may comprise audio feedback (e.g., a tone, simulated speech, etc.). In one embodiment, the ASR 135 converts the words for use by the action module 145, which uses the words to search for images in the content module 140 (e.g., an image gallery) using the metadata “Mom” to find any images having such metadata. The results are then displayed in view 411. In one embodiment, if no results are found, feedback indicates that there are no results (e.g., a blank view on display 121, no results found text indication, audio feedback, etc.).

In one embodiment, the user utters second words 404 (e.g., “last year”), which occurs within a particular time from the utterance of the first words 403 (e.g., two seconds, three seconds, etc.). The results found for the metadata “Mom” are then searched by the action module 145, which uses the second words “last year” and converts the words to a phrase with a logical filler, such as creation date 2012. The feedback 433 is displayed to let the user know the electronic device 120 is processing the request. The action module then searches the results for content (e.g., images) having a creation date (or user assigned date) with the year “2012.” The results of the second search are shown in view 412.

In one example embodiment, a further search for further filtering the results from the second search is requested by a third utterance 405, for example “in Paris.” The feedback 434 is displayed to let the user know the electronic device 120 is processing the request. In one embodiment, the action module 145 uses the converted words (e.g., from the ASR 135) and forms a phrase for searching metadata of the previous results for the location of Paris (e.g., either for the term “Paris” or a converted GPS coordinates for Paris, etc.). The result is then shown in the view 413. In one embodiment, the resulting content may then be selected 425 (e.g., touching or tapping a display) and the view 414 shows the content in a full-screen mode.

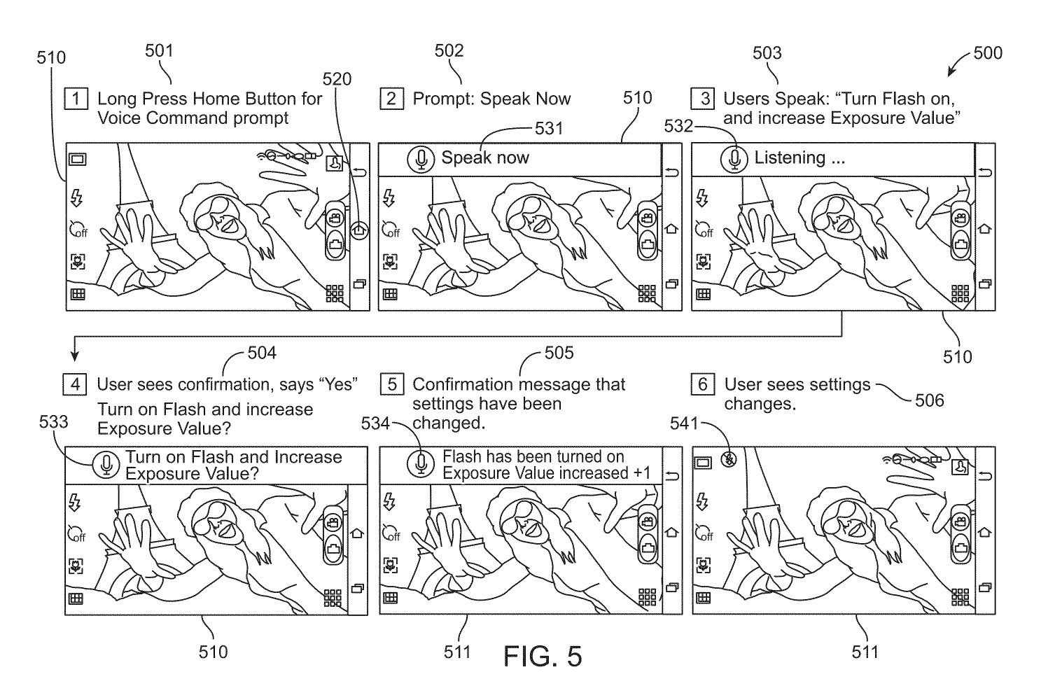

FIG. 5 shows an example scenario 500 for voice activated control within an application space for an electronic device 120, according to an embodiment. In one embodiment, the example scenario 500 comprises a user interacting with a camera application showing a view 510 (e.g., on display 121) for showing an image frame for capturing images. In one embodiment, a user activates the ASR 135 for receiving voice signals from a user by an activation event (e.g., long press 501 of a button 520, or any other appropriate activation technique).

In one embodiment, a dialog module responds to the activation 501 with a reply/feedback 531 (e.g., speak now) and prompts 502 the user to speak. In one embodiment, the user speaks 503 and utters the words “turn flash on, and increase exposure value.” In one embodiment, a feedback 532 is displayed to let the user know the electronic device 120 is listening to the utterance. In one embodiment, the ASR 135 converts the words for use by the action module 145, which uses the words to control the in-use application (e.g., the camera application) using the words “turn flash on” to create a phrase to turn on the flash function of the application, and increase exposure to increase the exposure function. Feedback 533 confirms the user's utterance to check if the ASR 135 and the action module 145 correctly interpreted the user's utterance and the user is prompted to enter a second utterance 504 (e.g., Yes or No).

In one embodiment, second utterance 504 results in view 511 with a confirmation 505 and feedback 534 indicating the changes that were made. In view 511 the user may see the results 506 with function indicator 541 for the flash changed, and the exposure of the image in the frame adjusted in view 511.

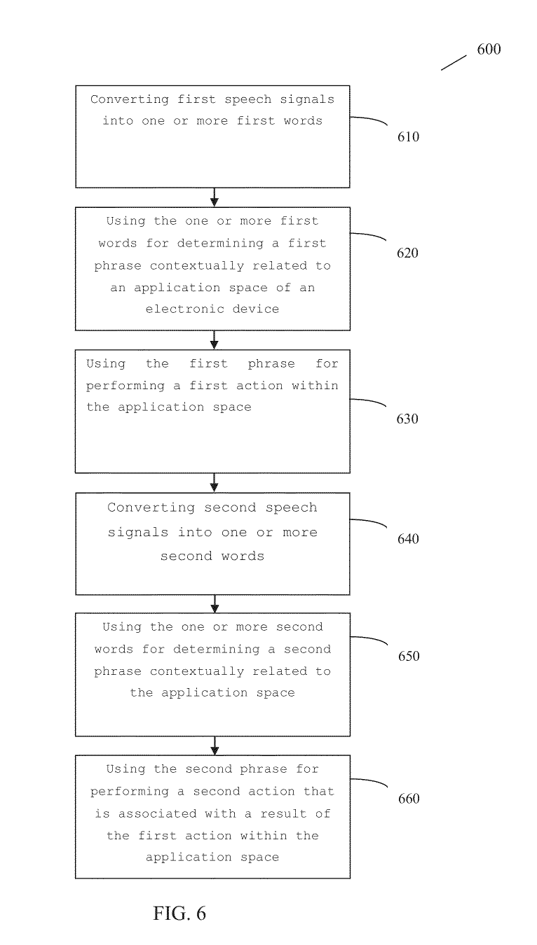

FIG. 6 shows a block diagram of a flowchart 600 for voice activated search or control within an application space for an electronic device (e.g., electronic device 120), according to an embodiment. In one embodiment, flowchart 600 begins with block 610 where first speech signals are converted into one or more first words (e.g., using an ASR 135). In block 620, the one or more first words are used for determining a first phrase that is contextually related to an application space of an electronic device. In block 630 the first phrase is used for performing a first action (e.g., a first search, a first function or setting change, etc.) within the application space (e.g., a camera application, a gallery application, a media application, a calendar application, etc.).

In one embodiment, in block 640 second speech signals are converted into one or more second words. In one embodiment, in block 650 the one or more second words are used for determining a second phrase that is contextually related to the application space. In one embodiment, in block 660 the second phrase is used for performing a second action that is associated with a result of the first action within the application space.

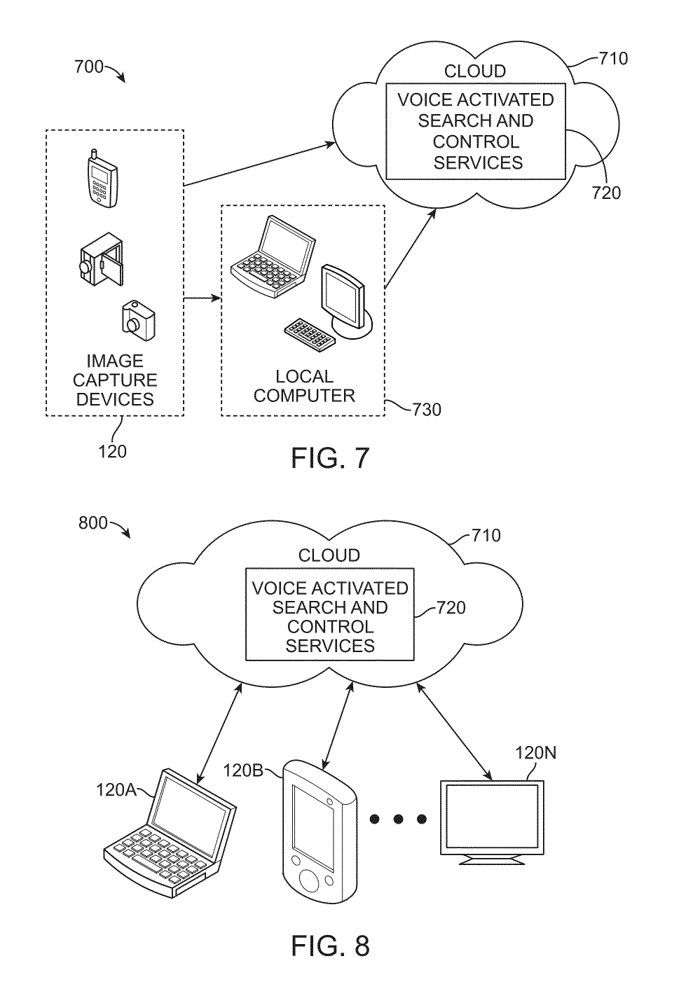

FIGS. 7 and 8 illustrate examples of networking environments 700 and 800 for cloud in which voice activated search and control embodiments described herein may utilize. In one embodiment, in the environment 700, the cloud 710 provides services 720 (such as voice activated search and control, social networking services, among other examples) for user computing devices, such as electronic device 120. In one embodiment, services may be provided in the cloud 710 through cloud computing service providers, or through other providers of online services. In one example embodiment, the cloud-based services 720 may include voice activated search and control services that uses any of the techniques disclosed, a media storage service, a social networking site, or other services via which media (e.g., from user sources) are stored and distributed to connected devices.

In one embodiment, various electronic devices 120 include image or video capture devices to capture one or more images or video, create or share images, etc. In one embodiment, the electronic devices 120 may upload one or more digital images to the service 720 on the cloud 710 either directly (e.g., using a data transmission service of a telecommunications network) or by first transferring the comments and/or one or more images to a local computer 730, such as a personal computer, mobile device, wearable device, or other network computing device.

In one embodiment, as shown in environment 800 in FIG. 8, cloud 710 may also be used to provide services that include voice activated search and control embodiments to connected electronic devices 120A-120N that have a variety of screen display sizes. In one embodiment, electronic device 120A represents a device with a mid-size display screen, such as what may be available on a personal computer, a laptop, or other like network-connected device. In one embodiment, electronic device 120B represents a device with a display screen configured to be highly portable (e.g., a small size screen). In one example embodiment, electronic device 120B may be a smartphone, PDA, tablet computer, portable entertainment system, media player, wearable device, or the like. In one embodiment, electronic device 120N represents a connected device with a large viewing screen. In one example embodiment, electronic device 120N may be a television screen (e.g., a smart television) or another device that provides image output to a television or an image projector (e.g., a set-top box or gaming console), or other devices with like image display output. In one embodiment, the electronic devices 120A-120N may further include image capturing hardware. In one example embodiment, the electronic device 120B may be a mobile device with one or more image sensors, and the electronic device 120N may be a television coupled to an entertainment console having an accessory that includes one or more image sensors.

In one or more embodiments, in the cloud-computing network environments 700 and 800, any of the embodiments may be implemented at least in part by cloud 710. In one embodiment example, voice activated search and control techniques are implemented in software on the local computer 730, one of the electronic devices 120, and/or electronic devices 120A-N. In another example embodiment, the voice activated search and control techniques are implemented in the cloud and applied to media as they are uploaded to and stored in the cloud. In this scenario, the voice activated search and control embodiments may be performed using media stored in the cloud as well.

In one or more embodiments, media is shared across one or more social platforms from a single electronic device 120. Typically, the shared media is only available to a user if the friend or family member shares it with the user by manually sending the media (e.g., via a multimedia messaging service (“MMS”)) or granting permission to access from a social network platform. Once the media is created and viewed, people typically enjoy sharing them with their friends and family, and sometimes the entire world. Viewers of the media will often want to add metadata or their own thoughts and feelings about the media using paradigms like comments, “likes,” and tags of people.

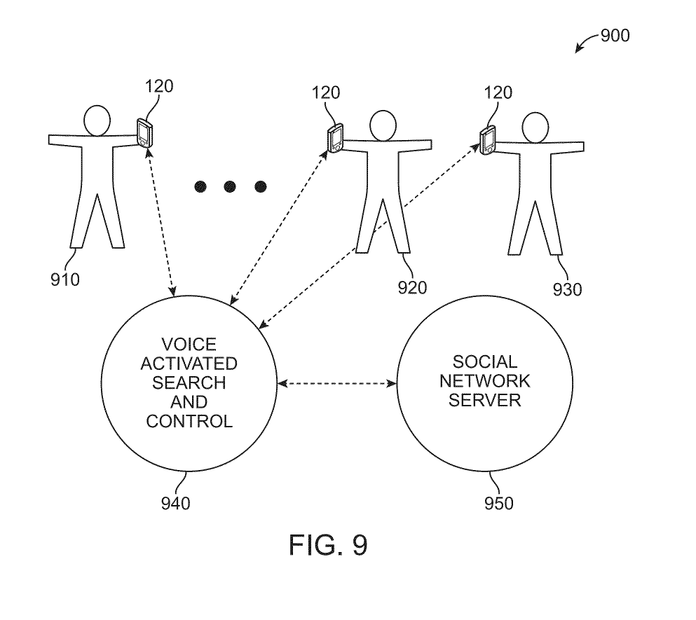

FIG. 9 is a block diagram 900 illustrating example users of a voice activated search and control system according to an embodiment. In one embodiment, users 910, 920, 930 are shown, each having a respective electronic device 120 that is capable of capturing digital media (e.g., images, video, audio, or other such media) and providing voice activated search and control. In one embodiment, the electronic devices 120 are configured to communicate with a voice activated search and control controller 940, which may be a remotely-located server, but may also be a controller implemented locally by one of the electronic devices 120. In one embodiment where the voice activated search and control controller 940 is a remotely-located server, the server may be accessed using the wireless modem, communication network associated with the electronic device 120, etc. In one embodiment, the voice activated search and control controller 940 is configured for two-way communication with the electronic devices 120. In one embodiment, the voice activated search and control controller 920 is configured to communicate with and access data from one or more social network servers 950 (e.g., over a public network, such as the Internet).

In one embodiment, the social network servers 950 may be servers operated by any of a wide variety of social network providers (e.g., Facebook®, Instagram®, Flickr®, and the like) and generally comprise servers that store information about users that are connected to one another by one or more interdependencies (e.g., friends, business relationship, family, and the like). Although some of the user information stored by a social network server is private, some portion of user information is typically public information (e.g., a basic profile of the user that includes a user's name, picture, and general information). Additionally, in some instances, a user's private information may be accessed by using the user's login and password information. The information available from a user's social network account may be expansive and may include one or more lists of friends, current location information (e.g., whether the user has “checked in” to a particular locale), additional images of the user or the user's friends. Further, the available information may include additional information (e.g., metatags in user photos indicating the identity of people in the photo or geographical data. Depending on the privacy setting established by the user, at least some of this information may be available publicly. In one embodiment, a user that desires to allow access to his or her social network account for purposes of aiding the comment or media sharing controller 940 may provide login and password information through an appropriate settings screen. In one embodiment, this information may then be stored by the voice activated search and control controller 940. In one embodiment, a user's private or public social network information may be searched and accessed by communicating with the social network server 950, using an application programming interface (“API”) provided by the social network operator.

In one embodiment, the voice activated search and control controller 940 performs operations associated with a voice activated search and control application or method. In one example embodiment, the voice activated search and control controller 940 may receive media from a plurality of users (or just from the local user), determine relationships between two or more of the users (e.g., according to user-selected criteria), and transmit media to one or more users based on the determined relationships.

In one embodiment, the voice activated search and control controller 940 need not be implemented by a remote server, as any one or more of the operations performed by the voice activated search and control controller 940 may be performed locally by any of the electronic devices 120, or in another distributed computing environment (e.g., a cloud computing environment). In one embodiment, the sharing of media may be performed locally at the electronic device 120.

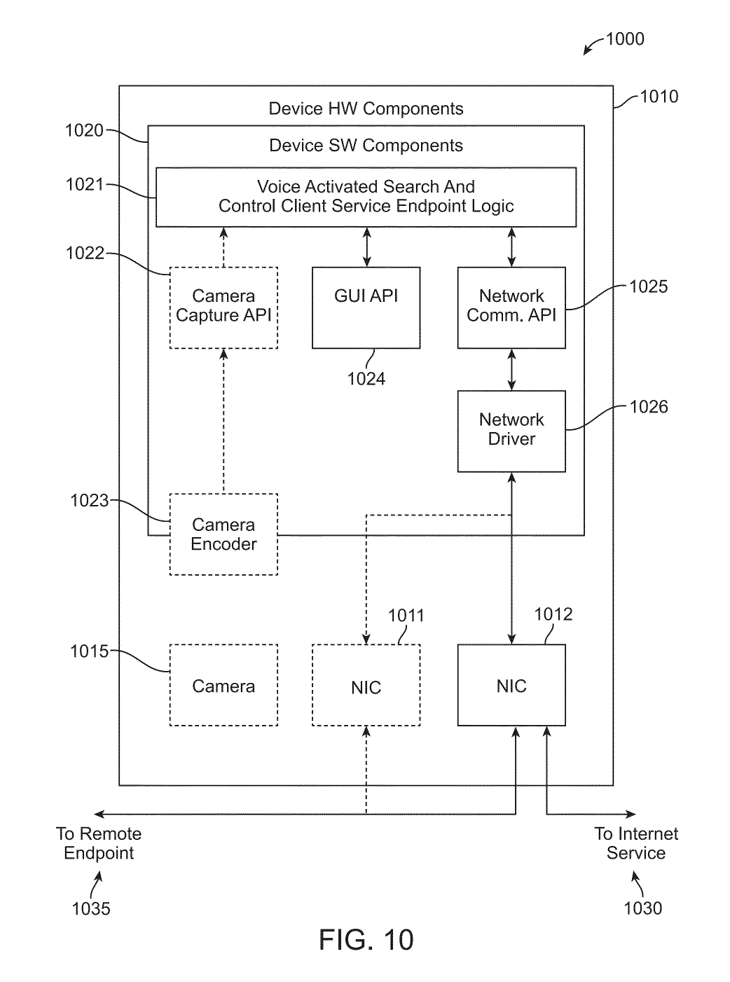

FIG. 10 shows an architecture for a local endpoint host 1000, according to an embodiment. In one embodiment, the local endpoint host 1000 comprises a hardware (HW) portion 1010 and a software (SW) portion 1020. In one embodiment, the HW portion 1010 comprises the camera 1015, network interface (NIC) 1011 (optional) and NIC 1012 and a portion of the camera encoder 1023 (optional). In one embodiment, the SW portion 1020 comprises comment and photo client service endpoint logic 1021, camera capture API 1022 (optional), a graphical user interface (GUI) API 1024, network communication API 1025, and network driver 1026. In one embodiment, the content flow (e.g., text, graphics, photo, video and/or audio content, and/or reference content (e.g., a link)) flows to the remote endpoint in the direction of the flow 1035, and communication of external links, graphic, photo, text, video and/or audio sources, etc. flow to a network service (e.g., Internet service) in the direction of flow 1030.

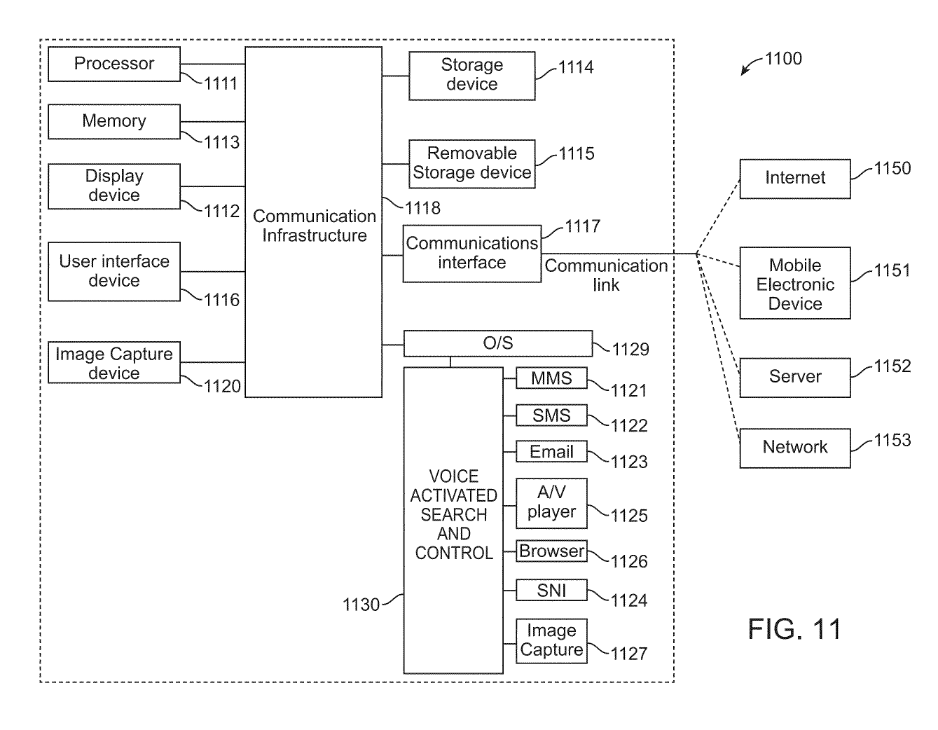

FIG. 11 is a high-level block diagram showing an information processing system comprising a computing system 1100 implementing an embodiment. The system 1100 includes one or more processors 1111 (e.g., ASIC, CPU, etc.), and can further include an electronic display device 1112 (for displaying graphics, text, and other data), a main memory 1113 (e.g., random access memory (RAM)), storage device 1114 (e.g., hard disk drive), removable storage device 1115 (e.g., removable storage drive, removable memory module, a magnetic tape drive, optical disk drive, computer-readable medium having stored therein computer software and/or data), user interface device 1116 (e.g., keyboard, touch screen, keypad, pointing device), and a communication interface 1117 (e.g., modem, wireless transceiver (such as WiFi, Cellular), a network interface (such as an Ethernet card), a communications port, or a PCMCIA slot and card). The communication interface 1117 allows software and data to be transferred between the computer system and external devices. The system 1100 further includes a communications infrastructure 1118 (e.g., a communications bus, cross-over bar, or network) to which the aforementioned devices/modules 1111 through 1117 are connected.

The information transferred via communications interface 1117 may be in the form of signals such as electronic, electromagnetic, optical, or other signals capable of being received by communications interface 1117, via a communication link that carries signals and may be implemented using wire or cable, fiber optics, a phone line, a cellular phone link, an radio frequency (RF) link, and/or other communication channels.

In one implementation of an embodiment in a mobile wireless device such as a mobile phone, the system 1100 further includes an image capture device such as a camera 127. The system 1100 may further include application modules as MMS module 1121, SMS module 1122, email module 1123, social network interface (SNI) module 1124, audio/video (AV) player 1125, web browser 1126, image capture module 1127, etc.

The system 1100 further includes a voice activated search and control processing module 1130 as described herein, according to an embodiment. In one implementation of said voice activated search and control processing module 1130 along an operating system 1129 may be implemented as executable code residing in a memory of the system 1100. In another embodiment, such modules are in firmware, etc.

One or more embodiments, use features of WebRTC for acquiring and communicating streaming data. In one embodiment, the use of WebRTC implements one or more of the following APIs: MediaStream (e.g., to get access to data streams, such as from the user's camera and microphone), RTCPeerConnection (e.g., audio or video calling, with facilities for encryption and bandwidth management), RTCDataChannel (e.g., for peer-to-peer communication of generic data), etc.

In one embodiment, the MediaStream API represents synchronized streams of media. For example, a stream taken from camera and microphone input may have synchronized video and audio tracks. One or more embodiments may implement an RTCPeerConnection API to communicate streaming data between browsers (e.g., peers), but also use signaling (e.g., messaging protocol, such as SIP or XMPP, and any appropriate duplex (two-way) communication channel) to coordinate communication and to send control messages. In one embodiment, signaling is used to exchange three types of information: session control messages (e.g., to initialize or close communication and report errors), network configuration (e.g., a computer's IP address and port information), and media capabilities (e.g., what codecs and resolutions may be handled by the browser and the browser it wants to communicate with).

In one embodiment, the RTCPeerConnection API is the WebRTC component that handles stable and efficient communication of streaming data between peers. In one embodiment, an implementation establishes a channel for communication using an API, such as by the following processes: client A generates a unique ID, Client A requests a Channel token from the App Engine app, passing its ID, App Engine app requests a channel and a token for the client's ID from the Channel API, App sends the token to Client A, Client A opens a socket and listens on the channel set up on the server. In one embodiment, an implementation sends a message by the following processes: Client B makes a POST request to the App Engine app with an update, the App Engine app passes a request to the channel, the channel carries a message to Client A, and Client A's onmessage callback is called.

In one embodiment, WebRTC may be implemented for a one-to-one communication, or with multiple peers each communicating with each other directly, peer-to-peer, or via a centralized server. In one embodiment, Gateway servers may enable a WebRTC app running on a browser to interact with electronic devices.

In one embodiment, the RTCDataChannel API is implemented to enable peer-to-peer exchange of arbitrary data, with low latency and high throughput. In one or more embodiments, WebRTC may be used for leveraging of RTCPeerConnection API session setup, multiple simultaneous channels, with prioritization, reliable and unreliable delivery semantics, built-in security (DTLS), and congestion control, and ability to use with or without audio or video.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

Embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method for voice activated search and control, comprising:
converting, using an electronic device, a first plurality of speech signals into one or more first words;
using the one or more first words for determining a first phrase contextually related to an application space;
using the first phrase for performing a first action within the application space;
converting, using the electronic device, a plurality of second speech signals into one or more second words;
using the one or more second words for determining a second phrase contextually related to the application space; and
using the second phrase for performing a second action that is associated with a result of the first action within the application space.

2. The method of claim 1, further comprising:
receiving the first plurality and the second plurality of speech signals using the electronic device.

3. The method of claim 2, wherein the first phrase and the second phrase are application specific phrases within the application space.

4. The method of claim 3, wherein the first action comprises a first search related to the application space.

5. The method of claim 4, wherein the second action comprises a second search within results of the first search.

6. The method of claim 5, wherein the application space comprises a camera application space, and the first search comprises searching for one or more images within an image gallery using the one or more first words.

7. The method of claim 5, wherein the first search comprises searching for a first portion of metadata associated with content associated with the application space and the second search comprises searching for a second portion of the metadata associated with content found from the first search.

8. The method of claim 3, wherein the first action comprises controlling application specific functions within the application space.

9. The method of claim 8, wherein the application specific functions comprise one or more settings functions.

10. The method of claim 7, wherein the electronic device provides feedback in response to the first and second plurality of speech signals.

11. The method of claim 10, a plurality of multiple chained speech signals result in a plurality of multiple chained associated actions within the application space upon the plurality of multiple chained speech signals occurring within a particular time period.

12. The method of claim 1, wherein the mobile electronic device comprises a mobile phone.

13. A system for voice activated search and control, comprising:
an electronic device including a microphone for receiving a plurality of speech signals;
an automatic speech recognition (ASR) engine that converts the plurality of speech signals into a plurality of words; and
an action module that uses one or more first words for determining a first phrase contextually related to an application space of the electronic device, uses the first phrase for performing a first action within the application space, uses one or more second words for determining a second phrase contextually related to the application space, and uses the second phrase for performing a second action that is associated with a result of the first action within the application space.

14. The system of claim 13, wherein the first phrase and the second phrase are application specific phrases within the application space.

15. The system of claim 14, wherein the first action comprises a first search related to the application space on the electronic device.

16. The system of claim 15, wherein the second action comprises a second search within results of the first search.

17. The system of claim 16, wherein the application space comprises a camera application space of the electronic device, and the first search comprises searching for one or more images within a content module using the one or more first words.

18. The system of claim 17, wherein the content module comprises image content that is stored on one of the electronic device, a cloud computing environment, or both the electronic device and the cloud computing environment.

19. The system of claim 15, wherein the first search comprises searching for a first portion of metadata associated with content that is associated with the application space and the second search comprises searching for a second portion of the metadata associated with content found from the first search.

20. The system of claim 13, wherein the first action comprises controlling application specific functions within the application space, wherein the application specific functions comprise one or more settings functions.

21. The system of claim 13, wherein the electronic device provides feedback in response to the plurality of speech signals.

22. The system of claim 21, wherein a plurality of multiple chained speech signals result in a plurality of multiple chained associated actions within the application space upon the plurality of multiple chained speech signals occurring within a particular time period.

23. The system of claim 13, wherein the mobile electronic device comprises a mobile phone.

24. A non-transitory computer-readable medium having instructions which when executed on a computer perform provides a method comprising:
converting a plurality of first speech signals into one or more first words using an electronic device;
using the one or more first words for determining a first phrase contextually related to an application space;
using the first phrase for performing a first action within the application space;
converting a plurality of second speech signals into one or more second words using the electronic device;
using the one or more second words for determining a second phrase contextually related to the application space; and
using the second phrase for performing a second action that is associated with a result of the first action within the application space.

25. The medium of claim 24, wherein the first phrase and the second phrase are application specific words within the application space.

26. The medium of claim 25, wherein the first action comprises a first search related to the application space, and the second action comprises a second search within results of the first search.

27. The medium of claim 26, wherein the first search comprises searching for a first portion of metadata associated with content associated with the application space and the second search comprises searching for a second portion of the metadata associated with content found from the first search.

28. The medium of claim 24, wherein the first action comprises controlling application specific functions within the application space.

29. The medium of claim 28, wherein the application specific functions comprise one or more settings functions.

30. The medium of claim 24, wherein a plurality of multiple chained speech signals result in a plurality of multiple chained associated actions within the application space upon the plurality of multiple chained speech signals occurring within a particular time period.
